(19) United States
(12) Patent Application Publication
(10) Pub. No.: US 2022/0143476 A1
(43) Pub. Date: May 12, 2022

(54) SHAFTS WITH INTERNAL BRACING FOR SPORTING GOODS AND METHODS OF MANUFACTURE

(71) Applicant: MCA GOLF, INC., Carlsbad, CA (US)

(72) Inventors: Stephen Greenwood, Brea, CA (US); Tod Boretto, Poway, CA (US)

(21) Appl. No.: 17/532,429

(22) Filed: Nov. 22, 2021

Related U.S. Application Data
(63) Continuation-in-part of application No. 16/783,742, filed on Feb. 6, 2020, now Pat. No. 11,179,899.
Application No. 16/783,742 is a division of application No. 15/639,849, filed on Jun. 30, 2017, now Pat. No. 10,596,770.
(60) Provisional application No. 62/357,767, filed on Jul. 1, 2016.

(51) Int. Cl. A63B 53/10; B29C 70/32; B29C 33/42

(52) U.S. Cl. CPC A63B 53/10; B29C 70/32; F42B 6/04; A63B 2209/02; B29C 33/42

(57) ABSTRACT

Disclosed herein are internally fluted shafts for sporting goods such as archery arrows, crossbow bolts, and golf clubs, as well as methods of manufacturing shafts with fluted internal diameters or bracing.

### CROSS-REFERENCE TO RELATED APPLICATIONS

This application is a continuation-in-part of U.S. application Ser. No. 16/783,742 filed Feb. 6, 2020 (now U.S. Pat. No. 11,179,899), which is a divisional of U.S. application Ser. No. 15/639,849 filed Jun. 30, 2017 (now U.S. Pat. No. 10,596,770), which claims the benefit of U.S. Provisional Application No. 62/357,767 filed Jul. 1, 2016, all of which are incorporated by reference herein in their entirety.

### BACKGROUND

In the sporting goods industry, there is a consistent drive to manufacture sporting goods having decreased weight and increased durability. Traditionally, shafts for sporting goods such as arrows were made from lightweight wood, bamboo, and reeds. To decrease their weight and produce arrows that are easier to shoot and that can fly farther, modern arrows are made from aluminum and fiber reinforced plastic. Carbon fiber, a type of fiber reinforced plastic, has been used since the 1990s as a lightweight material used to make arrows and other sporting goods. While modern materials are lighter in weight than traditional materials, modern materials are not as durable. Moreover, while modern materials are lighter, there is a consistent pursuit to decrease weight.

Modern arrows are typically made from a carbon fiber arrow shaft that is hollow, and include an arrow tip in the front of the arrow shaft, a nock in the rear of the arrow shaft, and fletching along the surface of the arrow shaft adjacent the nock. In flight, the hollow arrow shaft flexes slightly along its length in an oscillatory motion. Specifically, the action of shooting the arrow from the bow creates a deflection along the length of the arrow, which oscillates as the arrow travels. As a result, archers generally choose the arrow shaft and its components to match their equipment and to meet their shooting requirements. This includes choosing an arrow shaft having the correct length, weight, and stiffness. Archers chose an arrow shaft with a defined static spine, which is the stiffness of the arrow shaft and its resistance to bending. Based on their chosen arrow shaft and corresponding static spine, they then add tips, fletching, and nocks to tune the dynamic spine, which is the deflection of the arrow when fired from a bow. The physical properties of the arrow shaft, including the overall weight and the center of gravity of the arrow, affects the arrow performance.

For a specific arrow shaft having a particular length and static spine, the change in weight will adversely affect the static spine of the arrow shaft. The static spine of an arrow shaft is generally determined by the material of the arrow shaft, the thickness of the arrow shaft walls, and the length of the arrow shaft. Changing weight between arrow shafts made of the same carbon fiber material with the same length requires changing the wall thickness of the arrow shaft. The thinner walled arrows shafts will be lighter, but will have a lower static spine because the stiffness of the arrow shaft would decrease. Altering any one of the properties of the arrow shaft will affect the other. This limits the ability of the archer to choose a particular carbon fiber arrow shaft having a specific weight, length, and diameter with a specific static spine.

Shafts in other sporting goods, such as golf clubs, also have suffered from the above-described limitations of the prior art, and in particular the desire to achieve bending stiffness while not overburdening the shafts with thickness and weight that limit performance.

### SUMMARY

The present inventors have determined that it would be advantageous to provide, for various sporting goods, including, but not limited to, archery arrows, crossbow bolts, and golf clubs, a lightweight shaft having an overall stiffness comparable to the stiffness of a heavier shaft. It would further be advantageous to provide a thin walled sporting goods shaft having an overall stiffness comparable to a thicker walled shaft. It would further be advantageous to provide a sporting goods shaft with internal bracing with stiffness comparable to heavier weighted shafts.

Various embodiments of the present invention provide a shaft with internal bracing for sporting goods. The shaft with internal bracing is a hollow tube having a plurality of ribs formed along a length thereof. Due to the deflection of the shaft being perpendicular from its length, in some embodiments, the ribs are formed parallel with the length of the tube. By orienting the ribs perpendicular to the deflection and parallel with the length of the tube, the ribs can provide maximum bending stiffness to the tube by increasing the moment of inertia. The ribs increase the bending stiffness of the tube without adding additional thickness and weight. Due to the increased bending stiffness of the tube provided by the ribs, the wall thickness of the tube may be reduced while still maintaining the bending stiffness comparable to that of a shaft having a thicker wall. The decrease in wall thickness and the reduction of material reduces the weight of the shaft. This allows the shaft with internal bracing to have an exterior diameter and bending stiffness comparable to that of a standard shaft with a lighter weight.

In some embodiments, the shaft with internal bracing is a hollow tube having a plurality of ribs having a predetermined length formed along the length of the tube where one or more portions of the tube have a smooth bore. In some embodiments, the shaft with internal bracing is a hollow tube having a plurality of ribs formed along a length thereof at an angle. The plurality of ribs may be formed within the tube as a spiral, helix, or other similar patterns.

The shaft with internal bracing is formed on a mandrel formed with grooves corresponding to the desired ribs of the resulting shaft with internal bracing. Material is placed on the mandrel and the grooves on the mandrel are filled with the material. The material is cured. With the aid of releasing agents, the mandrel is removed leaving a hollow tube having a plurality of ribs formed on the interior thereof. In some embodiments, to create a smooth bore at one or both ends of the tube, portions of the ribs may be removed by grinding or other material removal methods known in the art.

In some embodiments, the invention provides a shaft with internal bracing for a golf club, comprising a tube having an outside diameter, an inside diameter, and a length, the tube tapered from a grip end to a tip end and comprising at least one layer of a carbon fiber material impregnated with epoxy, wherein the tube has an exterior surface that is substantially smooth, and an interior surface having a plurality of ribs formed thereon.

In some embodiments, the ribs are formed substantially parallel with the length of the tube.

In some embodiments, the ribs are formed along the length of the tube at an angle.

In some embodiments, the ribs span substantially the entire length of the tube.

In some embodiments, the ribs have a length that is less than that of the tube.

In some embodiments, the ribs have at least one of a triangular, circular, quadrilateral, and crescent shape in cross-section.

In some embodiments, the ribs are spaced equal distance apart on the interior surface of the tube.

In some embodiments, at least four ribs are formed on the interior surface of the tube.

In some embodiments, the ribs are tapered from the grip end to the tip end.

In some embodiments, the ribs are formed in multiple sections along the length of the tube.

In some embodiments, the invention provides method for manufacturing a shaft with internal bracing for a golf club, comprising rolling a carbon fiber material around an externally grooved mandrel, the mandrel tapered from a grip end to a tip end and having grooves extending longitudinally along a length thereof; curing the carbon fiber material over the grooved mandrel to form the shaft as a tapered tube having an essentially round cross-section along an exterior surface thereof and an interior surface defining spaced internal ribs formed in correspondence with the mandrel grooves; and removing the grooved mandrel from the shaft.

In some embodiments, the method further comprises removing material from the inside diameter of the shaft to create a smooth bore after said removing of the grooved mandrel.

In some embodiments, the carbon fiber material comprises a first unidirectional carbon fiber material.

In some embodiments, the first unidirectional carbon fiber material is rolled at an essentially 0 degree angle to the longitudinal axis of the grooved mandrel.

In some embodiments, the method further comprises wrapping a second unidirectional carbon fiber material around the first unidirectional carbon fiber material.

In some embodiments, the second unidirectional carbon fiber material is wrapped at an essentially 90 degree angle to the longitudinal axis of the grooved mandrel.

In some embodiments, the ribs are formed by the grooved mandrel to span substantially the entire length of the shaft.

In some embodiments, the ribs are formed by the grooved mandrel to span a predetermined length along the shaft.

In some embodiments, the grooved mandrel comprises a first mandrel body having the grooves and a second mandrel body without the grooves, said removing of the grooved mandrel comprising removing the first and second mandrel bodies from the shaft in opposite directions relative to one another.

In some embodiments, said removing of the grooved mandrel further comprises detaching the first and second mandrel bodies from one another.

Additional features and advantages of embodiments of the present invention are described further below. This summary section is meant merely to illustrate certain features of embodiments of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a perspective view of an arrow having an arrow shaft with internal bracing with a tip, fletching, and nock;

FIG. 2 is a cross-section view taken along lines 2-2 of FIG. 1 of the arrow shaft with internal bracing;

FIG. 2A is a cross-section view of an alternative arrow shaft with internal bracing having an alternative interior bore;

FIG. 2B is a cross-section view of an alternative arrow shaft with internal bracing having an alternative interior bore;

FIG. 2C is a cross-section view of an alternative arrow shaft with internal bracing having an alternative interior bore;

FIG. 3 is an exploded view of the arrow of FIG. 1;

FIG. 4 is a perspective view of the arrow tip in FIG. 3;

FIG. 5 is a cross-section view of the shaft of the arrow tip taken along lines 4-4 of FIG. 3;

FIG. 6 is a perspective view of the nock of FIG. 3;

FIG. 7 is a cross-section view of the nock shaft of the nock taken along lines 7-7 of FIG. 3;

FIG. 8 is an exploded view of an alternative embodiment of an arrow having the arrow shaft with internal bracing, a threaded bore insert, an arrow tip, a smooth bore insert, and a nock;

FIG. 9 is a perspective view of the threaded bore insert of FIG. 8;

FIG. 10 is a cross-section view of the threaded bore insert of the arrow tip taken along lines 10-10 of FIG. 8;

FIG. 11 is a perspective view of the smooth bore insert of FIG. 8;

FIG. 12 is a cross-section view of the smooth bore insert along lines 12-12 of FIG. 8;

FIG. 13 is a perspective view of an arrow shaft with internal bracing mandrel;

FIG. 14 is a side view of the arrow shaft with internal bracing mandrel;

FIG. 15 is a front view of the arrow shaft with internal bracing mandrel;

FIG. 16 is a back view of the arrow shaft with internal bracing mandrel;

FIG. 17 is a side view of an arrow shaft with internal bracing mandrel with carbon fiber material wrapped around the arrow shaft with internal bracing mandrel;

FIG. 18 is a cross-section view of the arrow shaft with internal bracing mandrel and carbon fiber taken along lines 18-18 of FIG. 17;

FIG. 19 is a cross-section view of the arrow shaft with internal bracing mandrel and carbon fiber taken along lines 19-19 of FIG. 17;

FIG. 20 is a side view of an alternative embodiment of the arrow shaft with internal bracing;

FIG. 21 is a cross-section view of the arrow shaft with internal bracing taken along lines 21-21 of FIG. 20;

FIG. 22 is a front view of the arrow shaft with internal bracing;

FIG. 23 is a side view of an alternative embodiment of a mandrel with carbon fiber material wrapped around the mandrel;

FIG. 24 is a side view of the alternative embodiment of the mandrel;

FIG. 25 is a cross-section view of the alternative embodiment of a mandrel with carbon fiber material wrapped around the mandrel taken along lines 25-25 of FIG. 23;

FIG. 26 is a side view of an alternative embodiment of the arrow shaft with internal bracing showing the ribs in dashed lines;

FIG. 27 is a cross-section view of the arrow shaft taken along lines 27-27 of FIG. 26;

FIG. 28 is a side view of an alternative embodiment of the reinforced arrow shaft mandrel with carbon fiber material wrapped around the mandrel to form the alternative embodiment of the arrow shaft with internal bracing;

FIG. 29 is a perspective view of a composite golf shaft;

FIG. 30 is a schematic drawing of a composite golf shaft pattern that has plies of composite material oriented in different directions to achieve desired golf shaft properties;

FIG. 31 depicts how the golf shaft pattern spirals from the tip end to the grip end after curing, and also shows how the golf shaft is clamped and load applied to measure stiffness of the shaft in frequency (cpm);

FIG. 32 shows the oscillation path of a golf shaft after a load has been applied at the tip end and then the shaft is allowed to oscillate until it stabilizes in the direction of the neutral axis;

FIG. 33 is a cross-section view of the grip end of a golf shaft with internal bracing;

FIG. 34 is a cross-section view of the tip end of the golf shaft of FIG. 33, showing the same shape of the flutes as at the grip end just smaller, showing that the flutes taper down in size as does the outer diameter of the golf shaft;

FIG. 35 shows a cross-section view of alternate designs having eight symmetric flutes that are rectangular, semicircular, or trapezoidal in shape;

FIG. 36 is a profile view of a golf shaft mandrel with varying taper rates extending from the grip end down towards the tip end;

FIG. 37 is a profile view that shows the flute channels that have been machined into the mandrel to produce flutes that are tapered and run the full length of the golf shaft;

FIG. 38 is a profile view that shows the flute channels that have been machined into the mandrels to produce flutes that exist in separate locations for desired performance properties;

FIG. 39 is a cross-section view of the mandrel showing that the flute channels are machined into the mandrel, and that the shape of the flutes can vary as well as the spacing, height and width of the flutes;

FIG. 40 is a profile view of the cross-sectional thickness of a flute, showing that the flute can follow the taper rate profile the golf shaft and also taper down in size from the grip end to the tip end;

FIG. 41 is a schematic view of a composite pattern layup construction that is placed within the flute channel to provide stiffness and strength; the process consists of orienting carbon or fiberglass prepreg and placing the prepreg into the flute channel so that it can co-cure with the continuous wraps of the outer plies of composite material;

FIG. 42 is a graph that shows the effect on the EI curve of a golf shaft that has the ribs (flutes) that extend the entire length of the shaft; the two plots on the graph are virtually identical when tested at a 0-degree direction and a 45-degree direction; and

FIG. 43 is a perspective view of a preferred embodiment golf shaft with internal bracing, with four symmetric semicircular shaped flute channels that extend from the large end of the golf shaft to a point down the shaft that does not extend beyond the midpoint of the shaft.

### DETAILED DESCRIPTION OF THE INVENTION

The description that follows includes preferred embodiments of the present invention, which are exemplary and specifically described with reference to the drawings. However, dimensions, materials, shapes, relative arrangements, and other constituent elements described in the following embodiments may be changed depending on the conditions of the various elements or devices or apparatuses to which the present invention is applied. Therefore, the scope of the present invention is not limited to the precise disclosure unless otherwise specified. For example, while some of the disclosure generally relates to archery arrows and arrow shafts, a person of skill in the art would appreciate that the teachings are applicable to other sporting goods incorporating shafts, such as crossbow bolts and golf clubs.

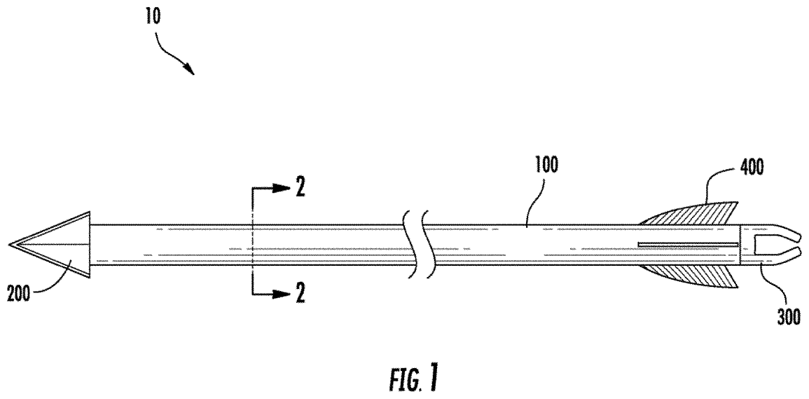

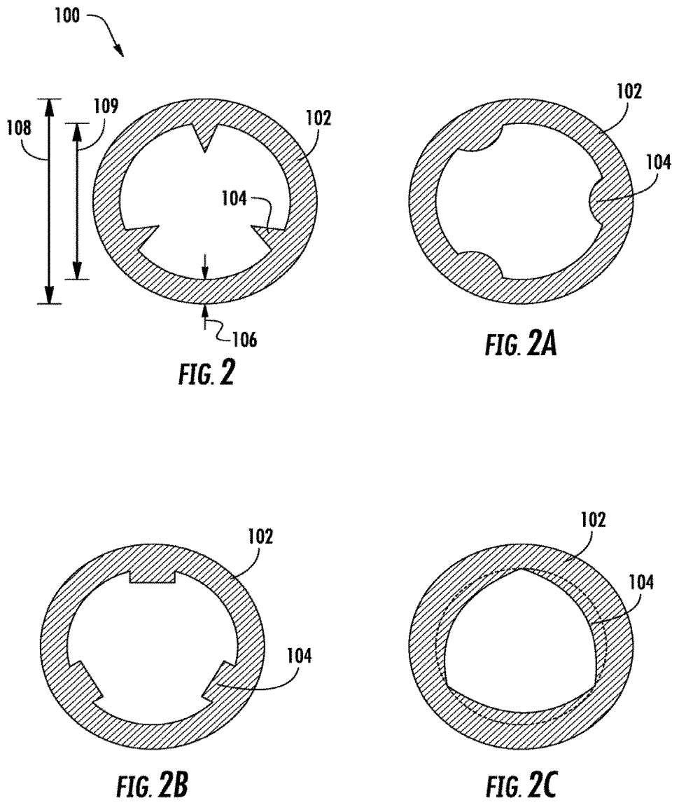

Referring initially to FIG. 1, a preferred embodiment of the arrow of the present invention is shown and generally designated 10. The arrow 10 includes an arrow shaft with internal bracing 100, an arrow tip 200, a nock 300, and fletching 400. The arrow shaft with internal bracing 100 is a cylindrical tube having a plurality of ribs, or protrusions, running along the length of the arrow shaft with internal bracing 100. As shown in FIG. 2, the arrow shaft with internal bracing 100 is a cylindrical tube 102 with an outside diameter 108, inside diameter 109, and a wall thickness 106. A plurality of ribs 104 is formed along the length of the cylindrical tube 102. In the preferred embodiment of the arrow shaft 100, three ribs 104 are formed on the interior of the cylindrical tube 102 and span the entire length of the cylindrical tube 102. Due to the deflection of the arrow shaft 100 being perpendicular from its length, the ribs 104 are formed parallel with the length of the cylindrical tube 102. By orienting the ribs 104 perpendicular to the deflection and parallel with the cylindrical tube 102, the ribs 104 provide maximum bending stiffness to the cylindrical tube 104 by increasing the moment of inertia. The arrow shaft can be made by molding fiber reinforced plastic, pultruding carbon fiber, or casting a metal, such as aluminum. The arrow shaft can be formed from any other material known to those of skill in that art.

The number and shape of the ribs 104 is not meant to be limiting and it is contemplated that various numbers of ribs 104 and various different shapes may be formed with the cylindrical tube 102 to vary the stiffness of the arrow shaft 100. As shown, the ribs 104 have a triangular shape. The triangular shape of the ribs 104 in FIG. 2 is not meant to be limiting and it is contemplated that various other shapes may be used such as the circular shape as shown in FIG. 2A, a quadrilateral shape as shown in FIG. 2B, a crescent shape as shown in FIG. 2C, or any other shape without departing from the scope and spirit of the invention. It is further contemplated that the internal bore of the arrow shaft with internal bracing 100 may be a different shape such as a circular shape, quadrilateral shape, and triangular shape or any other shape without departing from the scope and spirit of the invention.

The ribs 104 increase the bending stiffness of the cylindrical tube 102 without adding thickness and weight. Due to the increased bending stiffness of the cylindrical tube 102 provided by the ribs 104, the wall thickness 106 of the cylindrical tube 102 may be reduced while still maintaining the bending stiffness comparable to that of an arrow shaft having a thicker wall. The decrease in wall thickness and the reduction of material reduces the weight of the arrow shaft 100. This allows the arrow shaft with internal bracing 100 to have an exterior diameter 108 and bending stiffness comparable to that of a standard arrow shaft, but being lighter in weight. The arrow shaft with internal bracing 100 is a lightweight, high-strength arrow shaft.

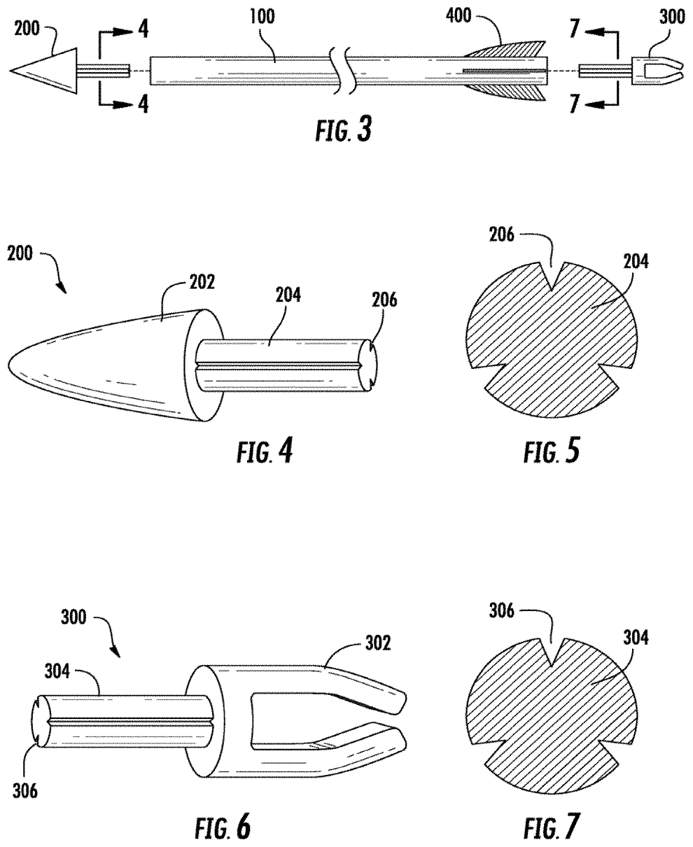

Referring now to FIG. 3, an exploded view of the arrow 10 is shown. The arrow 10 includes the arrow shaft with internal bracing 100, an arrow tip 200, fletching 400, and a nock 300. The arrow tip 200 includes a point 202 and a point shaft 204 formed with grooves 206 (shown in FIG. 4 and FIG. 5). The nock includes a nock body 302 and a nock shaft 304 formed with grooves 306 (shown in FIG. 6 and FIG. 7). The point shaft grooves 206 and the nock shaft grooves 306 correspond with the ribs 104 of the arrow shaft 100. This allows the point shaft 204 and the nock shaft 304 to be inserted into the arrow shaft 100.

The arrow tip 200 and nock 300 are internally fitted components that fit inside of the arrow shaft 100. Non-limiting examples of internally fitted components that are arrow tips include broadhead adapters and target points. Non-limiting examples of internally fitted components that are nocks include standard nocks and lighted nocks. An insert may be an internally fitted component or may be used with an internally fitted component to fit an arrow tip or nock inside of arrow shaft. Non-limiting examples of inserts include screw-in inserts, standard inserts, and threaded inserts. Internally fitted components are specifically made to be disposed in the arrow shaft.

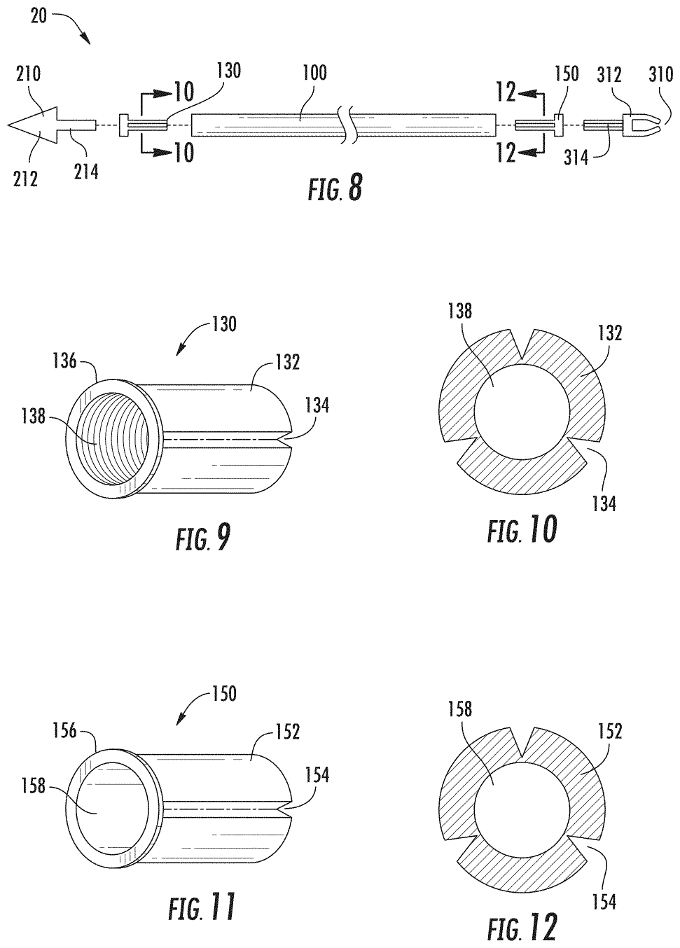

Referring now to FIG. 8, in conjunction with FIGS. 9-12, an alternative embodiment of the arrow is shown and generally designated 20. The arrow 20 includes the arrow shaft with internal bracing 100, a threaded bore insert 130, a standard arrow tip 210, a smooth bore insert 150, and a standard nock 310. The threaded bore insert 130 includes an elongated cylindrical body 132 formed with a threaded bore 138 extending a predetermined distance into the cylindrical body 132. The elongated cylindrical body 132 is further formed with a collar 136 on its open end. Formed into the exterior of the elongated cylindrical body 132 are grooves 134 corresponding to the ribs 104 of the arrow shaft. The smooth bore insert 150 includes an elongated cylindrical body 152 formed with a smooth bore 158 extending a predetermined distance into the cylindrical body 152. The elongated cylindrical body 152 is further formed with a collar 156 on its open end. Formed into the exterior of the elongated cylindrical body 152 are grooves 154 corresponding to the ribs 104 of the arrow shaft. It is contemplated that the threaded bore insert 130 and the smooth bore insert 150 may be modified to accommodate any standard sized arrows tips and nocks by modifying the corresponding threaded bore 138 and smooth bore 158. Further, it is contemplated that the threaded bore insert 130 and smooth bore insert 150 may be used to accept both arrow tips and nocks.

The threaded bore insert 130 and the smooth bore insert 150 allows the use of standard arrow tips 210 and nocks 310 with the arrow shaft with internal bracing 100. The ribs 104 of the arrow shaft with internal bracing 100 and the grooves 134 of the elongated cylindrical body 132 have enough clearance to allow the insertion of the elongated cylindrical body 132 into the arrow shaft with internal bracing 100. Once inserted into the arrow shaft with internal bracing 100, the collar 136 rests against the edge of the arrow shaft with internal bracing 100. Similarly, the grooves 154 formed on the elongated cylindrical body 152 have enough clearance to allow the insertion of the smooth bore insert 150 into the arrow shaft 100. The arrow tip 210 has a point with a threaded shaft 214. The threaded bore 138 of the thread bore insert 130 corresponds with the threaded shaft 214. The arrow tip 210 is attached to the arrow shaft with internal bracing 100 by threading the threaded shaft 214 into the threaded bore 138. On the opposite end, the nock 310 with the nock body 312 and shaft 314 is attached to the smooth bore insert 150 by inserting the shaft 314 into the smooth bore 158, where the smooth bore 158 is formed to accommodate the shaft 314. The exterior diameter 108 of the arrow shaft 100 being the same as standard arrows allow the seamless integration of the standard arrow tips 210 and nocks 310 when used in conjunction with the threaded bore insert 130 and the smooth bore insert 150.

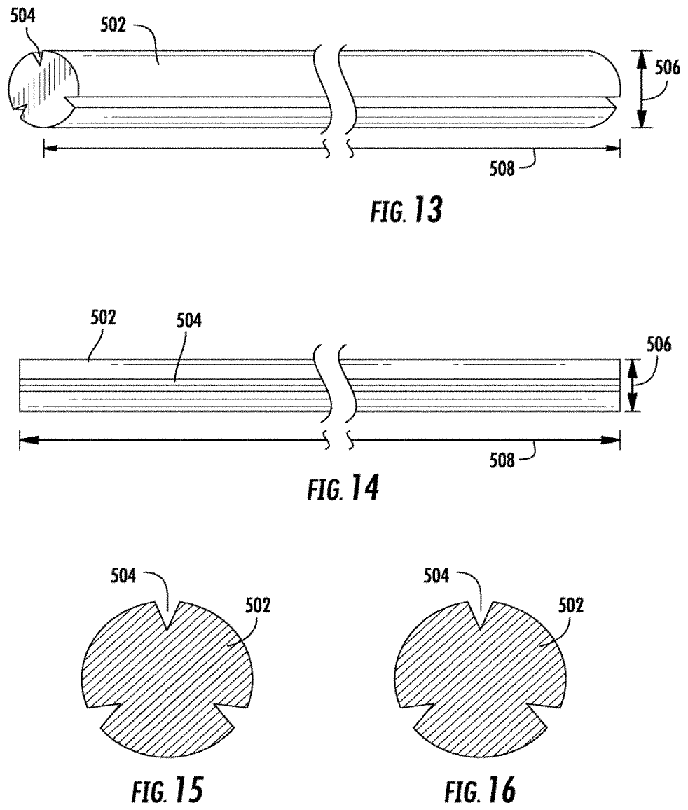

Referring now to FIG. 13, in conjunction with FIGS. 14-16, an arrow shaft with internal bracing mandrel is shown and generally designated 500. The arrow shaft with internal bracing mandrel 500 is used to form and manufacture the arrow shaft with internal bracing 100. The arrow shaft with internal bracing mandrel 500 includes an elongated body 502 with a diameter 506 and length 508. Along the length of the elongated body 502 are grooves 504 formed into the elongated body 502. The grooves 504 correspond to the desired shape, size, and orientation of the ribs 104 within the cylindrical shaft 102 of the arrow shaft with internal bracing 100. As shown, the grooves 504 are triangular in shape. The diameter 506 of the arrow shaft with internal bracing mandrel 500 corresponds to the desired internal diameter of the arrow shaft 100.

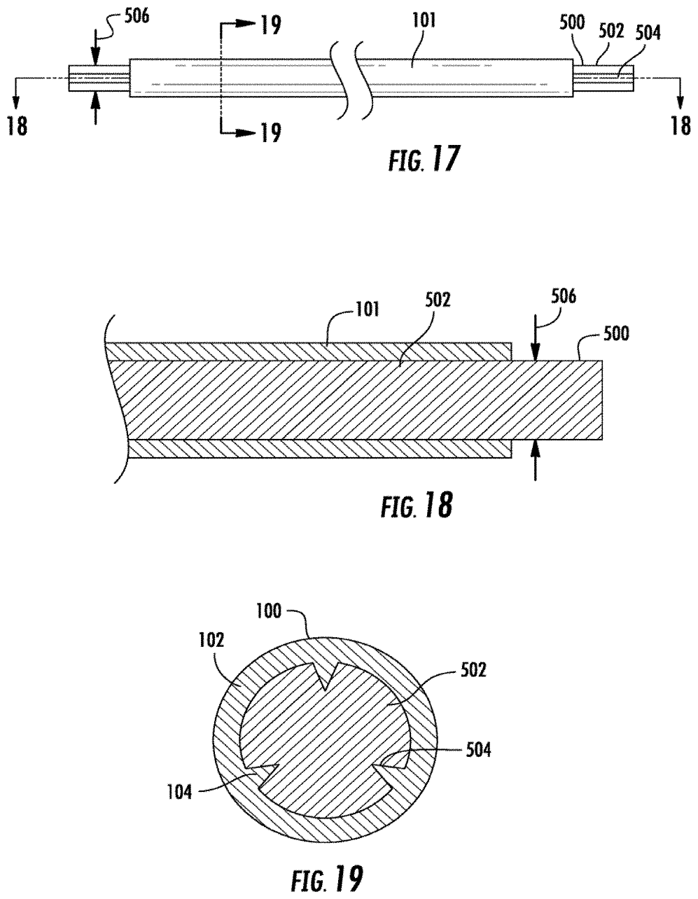

An example of a manufacturing method for the arrow shaft with internal bracing 100 is depicted in FIG. 17. Carbon fiber manufacturing is known in the art, and includes the wrapping of carbon fibers around a mandrel and impregnated with epoxy which is then heated and formed into the desired article of manufacture. For the present invention, a side view of the manufacturing method shows the use of the arrow shaft with internal bracing mandrel 500 wrapped with carbon fiber material 101. As shown in FIG. 19, the cross-section view taken along lines 19-19 of FIG. 17 shows the carbon fiber material 101 filling up the grooves 504 of the arrow shaft with internal bracing mandrel 500 to form the ribs 104 of the arrow shaft with internal bracing 100. Alternatively, the grooves 504 may be filled with another material to form the ribs 104 of the reinforced arrows shaft 100. The diameter 506 of the arrow shaft with internal bracing mandrel 500 forms the interior diameter 109 of the arrow shaft with internal bracing 100 and the amount of carbon fiber material 101 wrapped around the arrow shaft with internal bracing mandrel 500 forms the exterior diameter 108 of the arrow shaft 100. As shown in FIG. 18, a cross-section view of the arrow shaft with internal bracing mandrel 500 wrapped with carbon fiber material 101 taken along lines 18-18 of FIG. 17 shows the uniformity of the arrow shaft with internal bracing mandrel 500. This allows the arrow shaft with internal bracing mandrel 500 to be removed in either direction from the carbon fiber material 101 once the manufacturing process is complete.

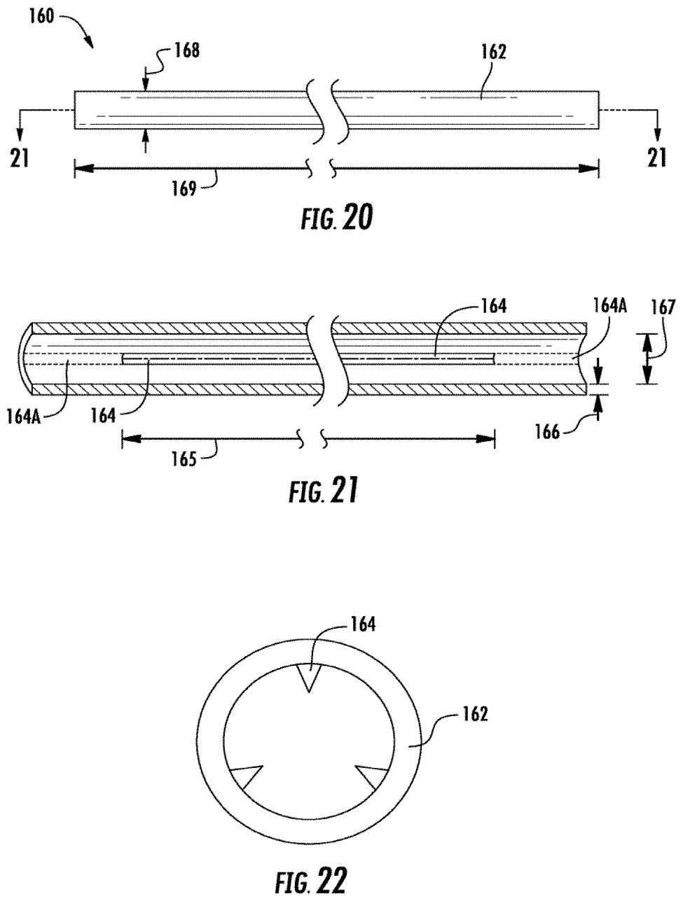

Referring now to FIG. 20, in conjunction with FIGS. 21 and 22, an alternative embodiment of the arrow shaft with internal bracing is shown and generally designated 160. The arrow shaft with internal bracing 160 is a cylindrical tube 162 having an inside diameter 167, an outside diameter 168, a length 169, and a wall thickness 166. The interior of the cylindrical tube 162 has a plurality of ribs 164 with a predetermined length 165 formed along its length. A portion 164A of the ribs 164 is removed from both ends of the cylindrical tube 162 to create a smooth bore opening. This enables the use of standard arrow tips, nocks, and various accessories with the arrow shaft with internal bracing 160.

Arrow shaft with internal bracing 160 is manufactured using similar steps used to manufacture the arrow shaft with internal bracing 100. After the removal of the carbon fiber material 101 from the arrow shaft with internal bracing mandrel 500, an additional step is performed on the processed carbon fiber material 101. The removed carbon fiber material 101 is formed into a cylindrical tube 162 with ribs 164 running the entirety of the length 169 of the cylindrical tube. The portion 164A of the ribs 164 is removed by using a variety of techniques, such as by grinding or other material removal methods known in the art. This creates a cylindrical tube 162 with ribs 164 with a predetermined length 165 and the creation of the smooth bore opening on the cylindrical tube 162.

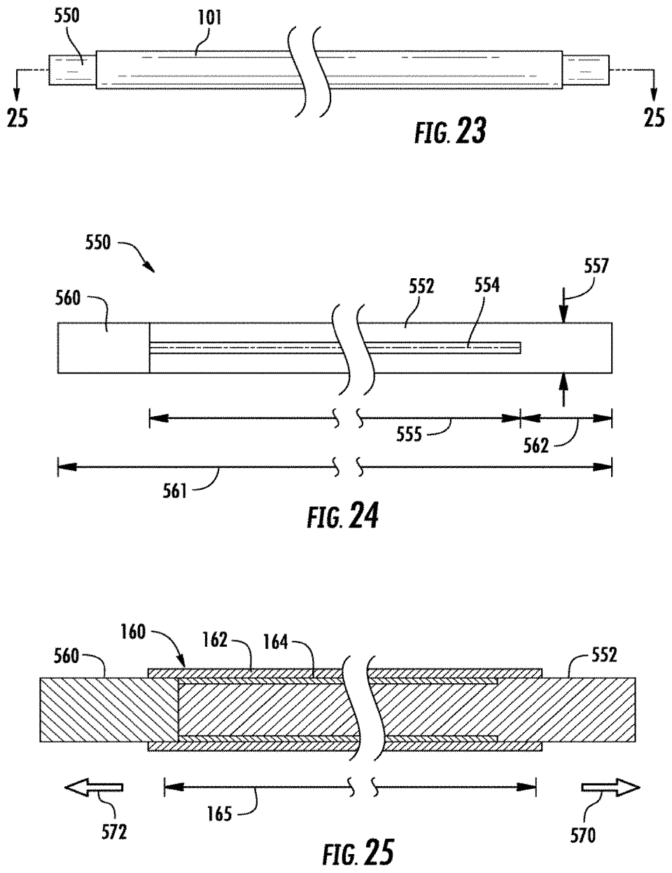

Referring now to FIGS. 23-25, an alternative manufacturing method for arrow shaft with internal bracing 160 is shown. A mandrel 550 is provided and wrapped with carbon fiber material 101. The mandrel 550 has a first body 552 formed with a groove 554 having a predetermined length 555 corresponding with the length 165 of the ribs 164 of the arrow shaft 160. The groove 554 abuts one end of the first body 552 while ending a distance 562 before the second end of the first body 552. Removably attached to the first end of the first body 552 is a second body 560. The second body 560 is not formed with any grooves. The first body 552 and second body has a diameter 557, corresponding to the diameter 167 of the arrow shaft 160, and when attached together has a total length 561. When attached together, first body 552 and second body 560 form mandrel 550.

As shown in FIG. 25, the cross-section view taken along lines 25-25 of FIG. 23 shows the carbon fiber material 101 filling up the grooves 554 of the first body 552 to form the ribs 164 of the arrow shaft with internal bracing 160. Alternatively, the grooves 554 may be filled with another material to form the ribs 164 of arrows shaft 160. The first body at distance 562 and the second body 560 are void of grooves 554 and thus no ribs 164 are formed in the arrow shaft 160 at the corresponding locations. The diameter 557 of the mandrel 550 forms the interior diameter 167 of the arrow shaft 160 and the amount of carbon fiber material 101 wrapped around the mandrel 550 forms the exterior diameter of the arrow shaft 160.

When the carbon fiber material 101 is cured, arrow shaft 160 is formed. To remove the mandrel 550 from the arrow shaft 160, the first body 552 is detached from the second body 560. The first body 552 is removed from the arrow shaft 160 in direction 570 and the second body 560 is removed from the arrow shaft 160 in direction 572. The separation of the mandrel 550 into two pieces allows the mandrel to be removed from the arrow shaft. Without separation of the mandrel 550, the ribs 164 of the arrow shaft 164 will prevent the mandrel 550 from being removed because the second body 560 without grooves and the first body 550 without grooves will be an obstruction preventing the removal of the arrow shaft 160.

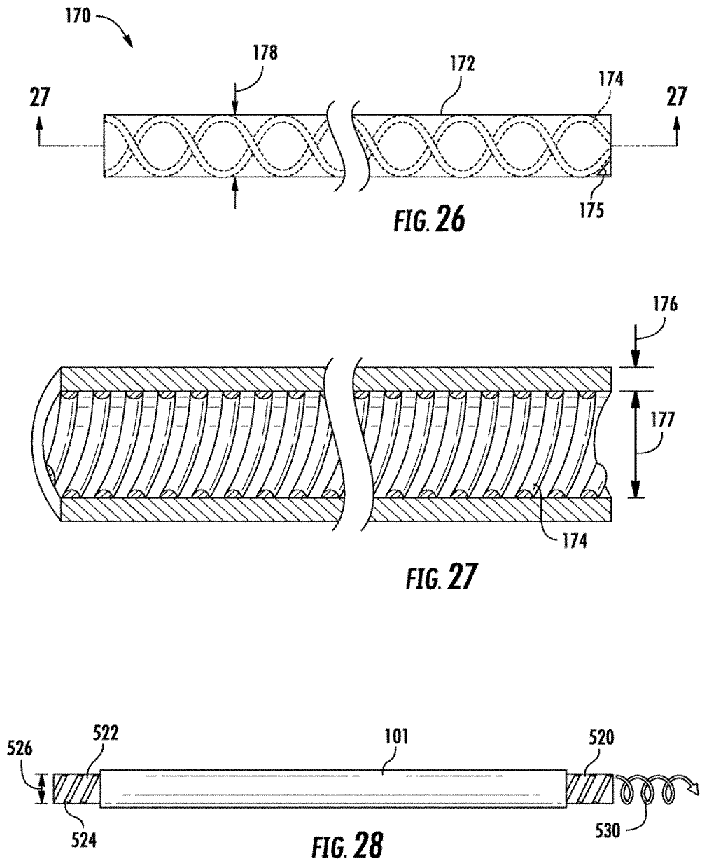

Referring now to FIG. 26 and FIG. 27, an alternative embodiment of an arrow shaft with internal bracing is shown and generally designated 170. The arrow shaft with internal bracing 170 is a cylindrical tube 172 with a wall thickness 176 having a plurality of ribs 174 running along the length of the cylindrical tube 172 in a spiral pattern. In the preferred embodiment of the arrow shaft 172, two ribs 174 are formed on the interior of the cylindrical tube 172 and span the entire length of the cylindrical tube 172. Due to the deflection of the arrow shaft 170 being perpendicular from its length coupled with the constant rotation of the arrow shaft 170, the ribs 174 are formed as a spiral running along the length of the cylindrical tube 172 at an angle 175. Angle 175 can be between 0 and 90 degrees. By orienting the ribs 174 in this manner, the ribs 174 provide additional bending stiffness to the cylindrical tube 172. The number and shape of the ribs 174 is not meant to be limiting and it is contemplated that various numbers of ribs 174 and various different shapes may be formed with the cylindrical tube 172 to vary the stiffness of the arrow shaft 170. As shown, the ribs 174 have a circular shape. As described above, the ribs 174 increase the bending stiffness of the cylindrical tube 174 without adding thickness and weight.

An example of a manufacturing method for the arrow shaft with internal bracing 170 is depicted in FIG. 28. Carbon fiber manufacturing is known in the art, and includes the wrapping of carbon fibers around a mandrel and impregnated with epoxy which is then heated and formed into the desired article of manufacture. For the present invention, a side view of the manufacturing method shows the use of the arrow shaft with internal bracing mandrel 520 wrapped with carbon fiber material 101. The arrow shaft with internal bracing mandrel 520 is has an elongated cylindrical body 522 with a diameter 526 and formed with spiral grooves 524. The carbon fiber material 101 fills up the grooves 524 of the arrow shaft with internal bracing mandrel 520 to form the ribs 174 of the arrow shaft with internal bracing 170. The diameter 526 of the arrow shaft with internal bracing mandrel 520 forms the interior diameter of the arrow shaft with internal bracing 170 and the amount of carbon fiber material 101 wrapped around the arrow shaft with internal bracing mandrel 520 forms the exterior diameter of the arrow shaft 170. After the process is complete and the carbon fiber material 101 is processed into arrow shaft with internal bracing 170, the arrow shaft with internal bracing mandrel 520 is removed in direction 530. Direction 530 includes the rotation of the arrow shaft with internal bracing mandrel 520 as the arrow shaft with internal bracing mandrel 520 is advanced out. It is contemplated the mandrel may be removed in the opposite of direction 530. It is further contemplated that the arrow shaft with internal bracing may be rotated while advancing the arrow shaft with internal bracing mandrel 520 out.

Shafts with internal bracing substantially as described above for archery arrows can also be advantageous in the golf industry. As compared to arrow shafts, a golf shaft is much more prone to irregularities caused by an inconsistent spine and the location of the dynamic spine in reference to the club head. The spine irregularities are caused by a number of issues, but the primary reason for spine inconstancy is that, unlike an arrow shaft (which is typically a straight cylinder), a golf shaft is tapered (decreasing in diameter from the grip end to the tip end). Furthermore, the patterns that are used to construct a composite golf shaft are predominantly asymmetric, usually resulting a greater wall thickness towards the tip of the golf shaft (where the club head is bonded) as compared the grip end of the golf shaft, which is usually about twice the outer diameter compared to the tip. Due to these factors, the spine of a golf shaft is more difficult to locate than an arrow shaft and in essence spirals up the shaft from the tip end to the grip end.

To further complicate the marking location of the spine, the dynamic spine will most likely be different than the static spine. In the case of a tapered golf shaft, the dynamic spine is equivalent to the neutral axis of the shaft. This is achieved by clamping the grip end of the shaft and applying a load at the tip end of the shaft. Once the load is applied and removed before the completion of one cycle, the shaft will oscillate to its neutral axis and the location is marked.

How the shaft is oriented within the club head is solely up to the manufacturer. What is important though (as for arrows) is consistency—e.g., that within a dozen shafts or a set of irons and driver clubs that the dynamic spine is located in the same orientation. This can have a dramatic improvement on shot dispersion within a set of golf clubs or arrow shafts.

In various embodiments, the present invention provides a composite golf shaft with internal bracing. The golf shaft with internal bracing is a hollow tube, tapered from the tip to the grip end and having a plurality of ribs formed along the length thereof. Due to the deflection of the golf shaft being perpendicular from its length, in some embodiments the ribs are formed parallel with the length (longitudinal axis) of the tube. By orienting the ribs perpendicular to the deflection and parallel with the length of the tube, the ribs can provide maximum bending stiffness to the tube by increasing the EI (cross sectional stiffness) of each section where the ribs (flutes) exist. The ribs increase the bending stiffness of the tapered tube and can be modified in length, height, and distance to achieve desired properties. Due to the increased bending stiffness of the tube provided by the ribs, the wall thickness of the tapered tube may be reduced while still maintaining the bending stiffness comparable to that of a golf shaft having a thicker wall. The decrease in wall thickness and the reduction of material reduces the weight of the golf shaft. This allows the golf shaft with internal bracing to have an exterior diameter and bending stiffness comparable to that of a standard golf shaft with a lighter weight.

In some embodiments, the present invention also includes a feature whereby the flutes themselves taper in dimension from the grip end to the tip end. In some embodiments, the flutes taper both in the longitudinal axis and 90 degrees transverse to the axial direction. This allows the flutes to reduce in size as the flutes get closer towards the tip end of the golf shaft. This feature may be achieved by the manufacturing process described herein.

In some embodiments, the golf shaft with internal bracing is a tapered tube having a plurality of ribs having a predetermined length formed along the length of the tube. In some embodiments, portions of the ribs are removed from one or both ends, or the middle, of the tube. In some embodiments, the golf shaft with internal bracing is a tapered tube having a plurality of ribs formed along the length (longitudinal axis) of the tube at an angle. The plurality of ribs may be formed within the tapered tube as a spiral, helix, or other similar patterns.

To achieve conformity to USGA (United States Golf Association) rules that a golf shaft must be similar in performance regardless of location around the circumference of the golf shaft, it is preferred for the ribs/flutes to have at least four equal distant locations around the circumference of the internal diameter (e.g., four flute locations centered at 0, 90, 180 and 270 degree locations). By having at least four ribs of sufficient height and width to overcome the neutral axis of a non-ribbed golf shaft, the shaft will have a similar frequency around the circumference. In other embodiments, different numbers and/or locations of flutes may be provided. For example, one can place the flutes in eight locations or more based upon the space available.

In various embodiments, golf shafts with internal bracing as described herein can provide a similar dynamic bending response regardless of how the shaft is oriented into the club head eliminating the need to locate a single neutral axis and orient it into the club head. This ultimately leads to tighter shot dispersion, better accuracy, and uniform feel throughout a set of golf clubs. In addition, golf shafts with internal bracing as described herein have a significantly thicker wall thickness in the area of the rib, which increases the compressive and impact strength compared to a similar structure without any ribs. Having at least four discrete stiffer planes (spines) instead of a single stiff plane contained in all golf shafts dramatically reduces the shaft orbiting effect associated with a single stiff plane golf shaft.

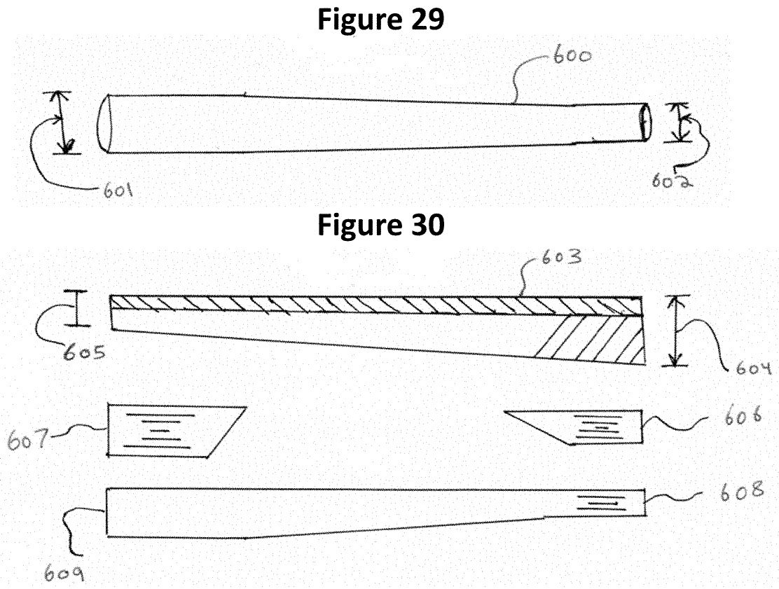

Referring now to FIG. 29, in conjunction with FIGS. 29-43, a golf shaft with internal bracing is shown and generally designated 600. FIG. 29 represents a typical golf shaft 600 that is hollow in design with a large end (grip end) 601 and tapering down toward the small end (tip) 602.

FIG. 30 is a schematic view of a typical pattern layup of a composite golf shaft beginning with a region of the layup where the fibers are oriented at a 45-degree fiber angle 603 which controls the tortional stiffness of the golf shaft. A typical golf shaft layup for ply 603 consists of a larger number of plies located at the small end 604 with a reducing number of plies as you extend to the large end 605. This reduction in plies creates an inherent imbalance in the composite structure resulting in what is referred to as a twisting spine. Patterns 606, 607 that are typically placed outboard of the torsional plies 603 also contribute to the spine imbalance to a composite shaft. The outermost plies 608, 609 extend from the small end to the large end of a typical composite golf shaft. If the full-length plies do not match the taper profile precisely, it can also contribute to the spine imbalance of a golf shaft.

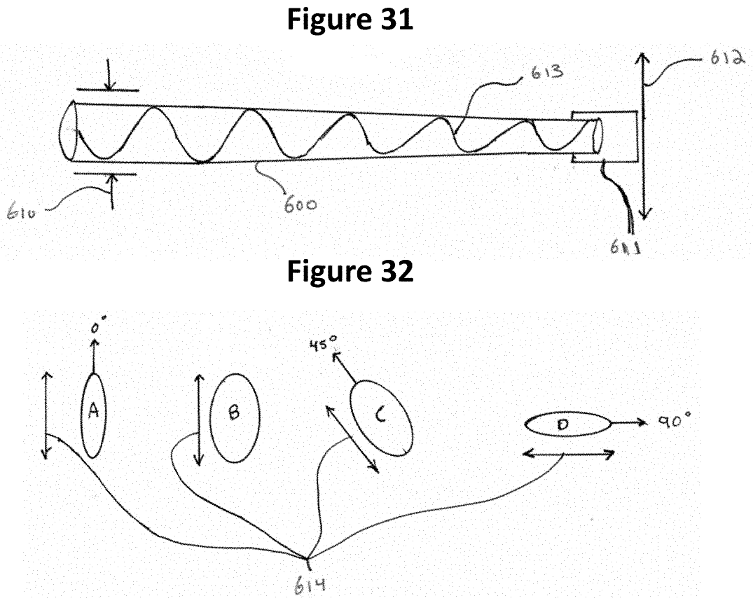

FIG. 31 represents a side view of a typical method for analyzing the stiffness of a golf shaft 600. The frequency analysis consists of clamping the large end of the shaft 610 with a fixed or pneumatic clamp with sufficient clamping force. Once the shaft is clamped at the large end, a weight of pre-determined amount is fixtured to the small end of the golf shaft 611. Once the weight is fixed onto the shaft, it is mechanically deflected 612 and released causing the energy to move into the shaft causing the shaft to flex 613. A machine captures the speed at which the shaft recovers from the load applied and is read in cycles per minute. A higher value indicates a stiffer shaft. This is also a test that identifies where the neutral axis is on the shaft.

Once the load is applied in a specific plane, the shaft will oscillate and stabilize to its neutral axis as is represented in FIG. 32. If the spine of the shaft or the neutral axis is in alignment to the load plane 614 one will observe an orbital path represented by the pattern marked with the letter A. This shows the initial dispersion as the shaft begins its oscillation. This is also the desired profile of oscillation. The path marked B shows the same golf shaft and the pattern of dispersion starts to increase in area. The path marked C shows the progression of oscillation which shows the plane transitioning into a 45-degree plane from a 0-degree plane. The path marked D shows the progression of oscillation into its final plane of orbit which can be up to 90 degrees different than the starting location of the initial orbit. As the spine of a shaft spirals up the shaft, due to the asymmetric patterns and wall thicknesses, the spine of the shaft can create different orbital patterns represented by A through D. It is necessary to locate the neutral axis based upon the shaft being under load because the spine can shift based upon a static load versus a dynamic load.

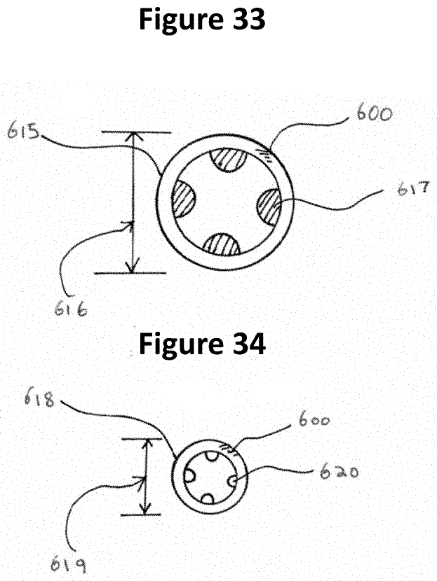

FIG. 33 is a cross sectional view of the large end 615 of the composite golf shaft 600, according to some embodiments. In this particular configuration, there are four equal distance spaced semi-circular flute channels 617 that are equal themselves in dimension. These internal braces (ribs) or flutes can be constant in dimension as the shaft progresses from a larger diameter 616 to a smaller diameter 619 towards the small end.

FIG. 34 is a cross sectional view of the small end 618 of the composite golf shaft 600, according to some embodiments. In this particular configuration, there are four equal distance spaced semi-circular flute channels 620 that are equal themselves in dimension. In the preferred embodiment, this particular cross-sectional shape is the desired shape based upon a number of factors such as: cost, manufacturability, etc.

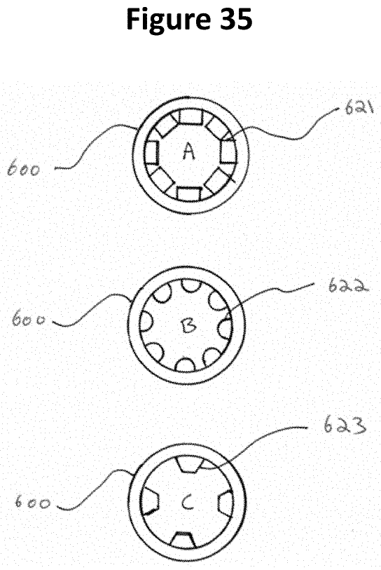

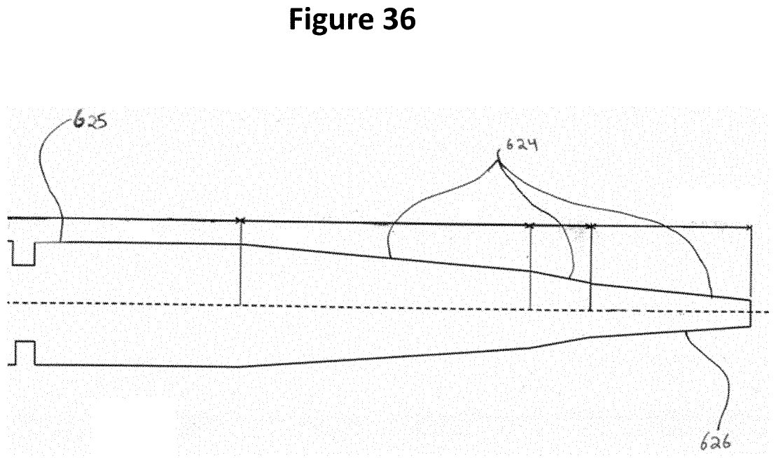

FIG. 35 represents some alternative fluted channel geometries, marked A, B, and C. The shape of the channel is usually constrained by the practical limits of machining the tooling, but the more predictable shapes like rectangular 621, semi-circular 622, and truncated cones 623 are all possible. The important factor in these particular embodiments is that the shapes need to be symmetric in their cross-sectional shape and also evenly spaced throughout the internal diameter of the golf shaft.

FIG. 36 represents a traditional tapered steel mandrel used for traditional composite golf shaft manufacturing. One can see that the mandrel increases in size from the tip side 626 up to the grip end 625. Between the large end 625 and the small end 626, the diameter tapers and can have multiple changes in taper 624 depending on the desired shaft properties.

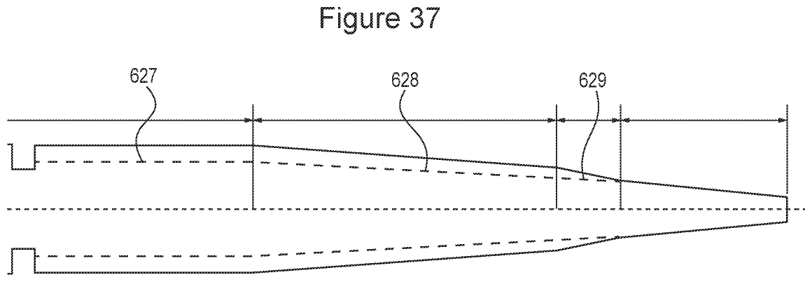

FIG. 37 is a side view profile of the golf shaft mandrel showing the recessed channels that are machined into the mandrel to manufacture the flutes. These channels can be constant depth 627 or a tapered depth 628. The transition where the channel exits to the mandrel surface 629 can be blended and tapered in both width and thickness as to not create a bulge in the outer surface of the golf shaft.

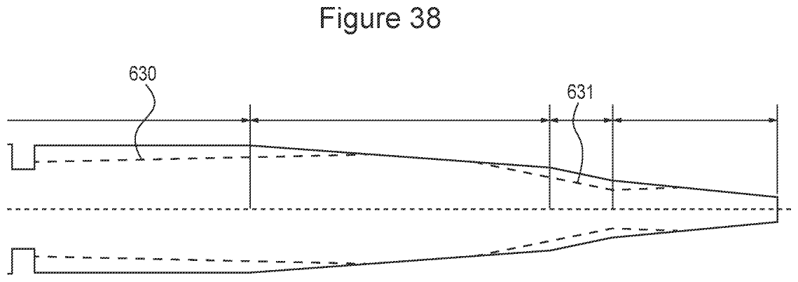

FIG. 38 is a side view profile of the golf shaft mandrel showing that the fluted channels can be discontinuous along the longitudinal axis of the golf shaft. The channel 630 in the large end for instance can have a different flute channel width and depth and taper rate. Within the same shaft, one could locate fluted channels 631 towards the tip end of the shaft which change in size and shape along with depth and taper rate.

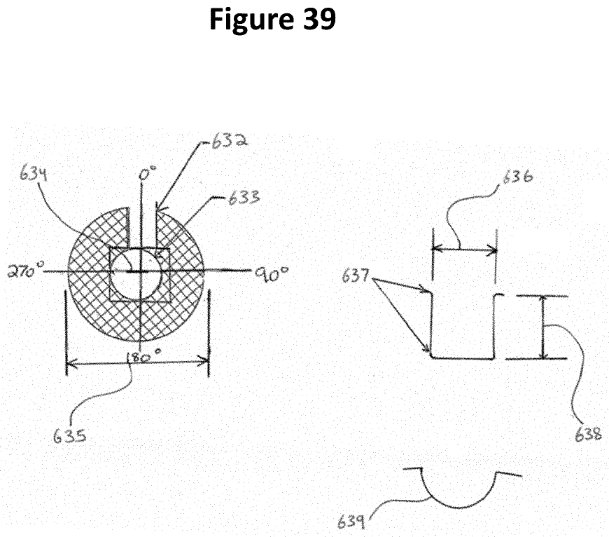

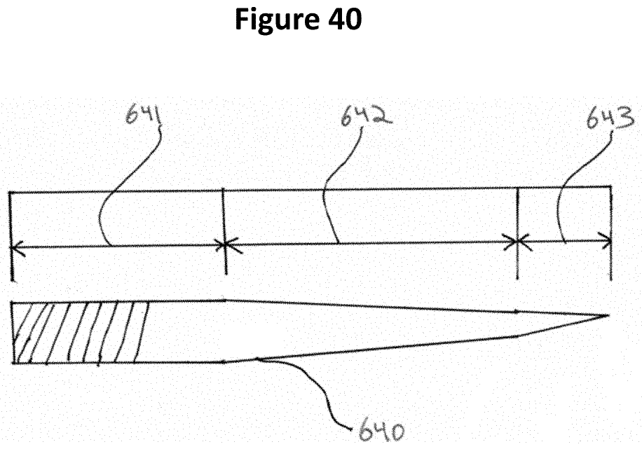

FIG. 39 is a cross sectional view of a flute channel design 632. This represents the channel shape of the mandrel itself in which composite material will be filled in and eventually become part of the golf shaft itself. The inner diameter 634 and transition of the channel of the flute to the inner core steel mandrel 633 can vary in depth and size depending on desired shaft properties. A plurality of these channels would be machined into the mandrel at equal distance apart from each other 635. The flute channel depth 636, width 638, and transition 637 can all vary depending on desired shaft properties. The channel shape 639 can also vary depending on machining costs and manufacturability.

FIG. 40 is a cross sectional view of the actual cross section of the composite thickness of the actual flute 640. As mentioned previously, the wall thickness can vary along the longitudinal axis of the shaft and can be constant thickness 641, or tapered 642, 643. This allows for a transition into the existing natural profile of the shaft once it is fully cured.

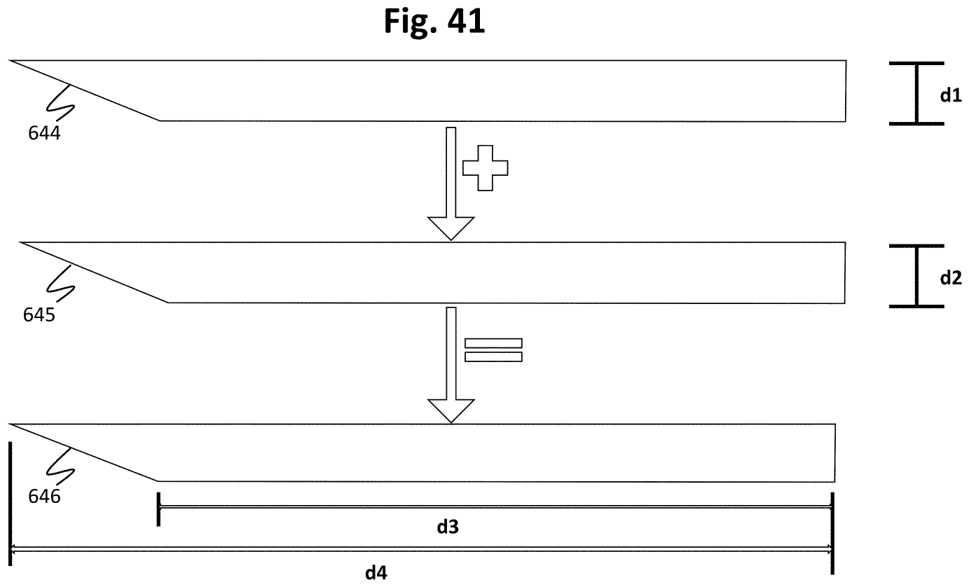

FIG. 41 is a pattern view of a composite layup construction which is placed into the machined channels in the mandrel. The layup can be achieved in a number of ways, but in the preferred embodiment the general layup consists of attaching a unidirectional carbon fiber prepreg at a 0-degree or axial direction 644, to a ply of unidirectional carbon fiber prepreg oriented at a radial or 90-degree orientation 645. The dimensions of these two plies can vary but for ease of manufacturing, the dimensions for d1 and d2 are usually the same dimension. Once the two materials are attached together using a debulking process, they are trimmed with the ends being tapered 646, so that when the material is placed into the flute channel that as the channel gets shallower where it meets up with the outer mandrel surface that it does not create a bulge in the structure. The length of the pattern layup d3 and the taper section d4 can also vary in length and taper rate depending on the fluted channel width and depth.

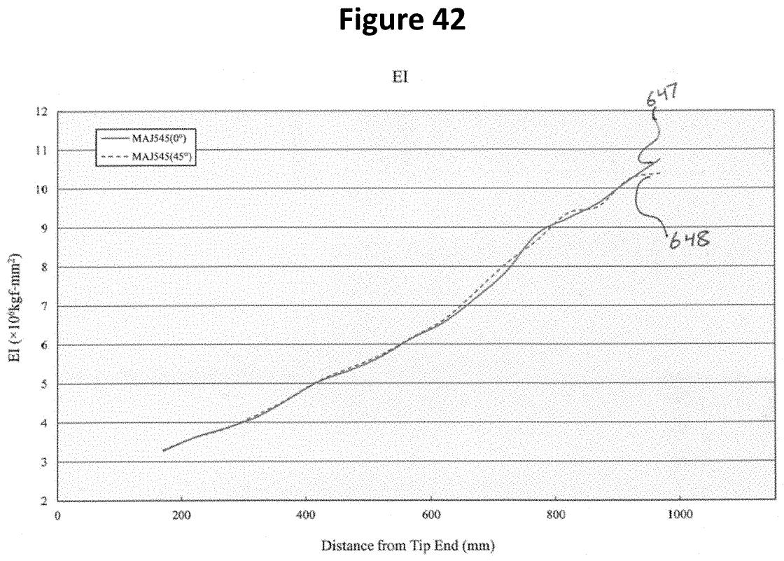

FIG. 42 is a graphical plot of actual shaft stiffness based upon the preferred embodiment shaft design that incorporates four symmetric flutes that are equally spaced within the internal diameter of the golf shaft. The curve represents the flexural stiffness (EI) curve of the fluted shaft design that is oriented at a 0-degree axis 647. The other curve plot represents that same shaft except it has been rotated to a 45-degree location 648. Normally (e.g., for standard golf shafts without internal bracing) the EI curve profile will change based upon the location of the spine in reference to the load. However, in the case of this embodiment golf shaft with four symmetric flutes equally spaced around the circumference, the profiles are close to identical.

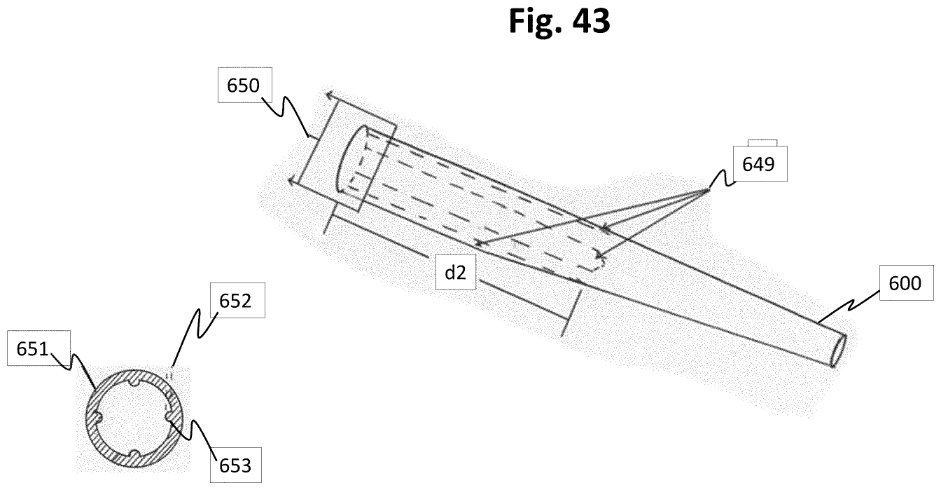

FIG. 43 is a schematic view of a preferred embodiment golf shaft with internal bracing 600. It consists of four symmetric fluted semi-circular channels 649 that extend from the large end of the golf shaft 650 up to the midpoint of the shaft (d2) and not beyond. The cross-sectional view 651 shows that the depth of the channels 652 can vary along with shape of the channel 653.

Although the present invention has been described herein with respect to preferred and alternative embodiments thereof, the forgoing descriptions are intended to be illustrative, and not restrictive. Those skilled in the art will realize that many modifications of the preferred and alternative embodiments could be made which would be operable, such as combining the various aspects of each preferred and alternative embodiments. All such modifications which are within the scope of the claims are intended to be within the scope and spirit of the present invention. The above description sets forth, rather broadly, a summary of the disclosed embodiments. There may be, of course, other features of the disclosed embodiments that will be appreciated by a person of skill in the art based on the description and may form the subject matter of claims. The features, functions, and advantages that have been discussed can be achieved independently in various embodiments of the disclosure or may be combined in yet other embodiments, further details of which can be seen with reference to the description and drawings.

The order in which the steps are presented is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention. Many modifications and other embodiments of the disclosure will come to mind to one skilled in the art to which this disclosure pertains having the benefit of the teachings presented in the foregoing descriptions and the associated drawings. The embodiments described herein are meant to be illustrative and are not intended to be limiting. Although specific terms are employed herein, they are used in a generic and descriptive sense only and not for purposes of limitation.

The invention is not limited in its application to the details of the construction and to the arrangement of the components set forth in the above description or as illustrated in the drawings. While it has been shown what are presently considered to be preferred embodiments of the present invention, it will be apparent to those skilled in the art that various changes and modifications can be made herein without departing from the scope and spirit of the invention.

1. A shaft with internal bracing for a golf club, comprising:
a tube having an outside diameter, an inside diameter, and a length, the tube tapered from a grip end to a tip end and comprising at least one layer of a carbon fiber material impregnated with epoxy,
wherein the tube has an exterior surface that is substantially smooth, and an interior surface having a plurality of ribs formed thereon.

2. The shaft of claim 1, wherein the ribs are formed substantially parallel with the length of the tube.

3. The shaft of claim 1, wherein the ribs are formed along the length of the tube at an angle.

4. The shaft of claim 1, wherein the ribs span substantially the entire length of the tube.

5. The shaft of claim 1, wherein the ribs have a length that is less than that of the tube.

6. The shaft of claim 1, wherein the ribs have at least one of a triangular, circular, quadrilateral, and crescent shape in cross-section.

7. The shaft of claim 1, wherein the ribs are spaced equal distance apart on the interior surface of the tube.

8. The shaft of claim 1, wherein at least four ribs are formed on the interior surface of the tube.

9. The shaft of claim 1, wherein the ribs are tapered from the grip end to the tip end.

10. The shaft of claim 5, wherein the ribs are formed in multiple sections along the length of the tube.

11. A method for manufacturing a shaft with internal bracing for a golf club, comprising:
rolling a carbon fiber material around an externally grooved mandrel, the mandrel tapered from a grip end to a tip end and having grooves extending longitudinally along a length thereof;
curing the carbon fiber material over the grooved mandrel to form the shaft as a tapered tube having an essentially round cross-section along an exterior surface thereof and an interior surface defining spaced internal ribs formed in correspondence with the mandrel grooves; and
removing the grooved mandrel from the shaft.

12. The method of claim 11, further comprising removing material from the inside diameter of the shaft to create a smooth bore after said removing of the grooved mandrel.

13. The method of claim 11, wherein the carbon fiber material comprises a first unidirectional carbon fiber material.

14. The method of claim 13, wherein the first unidirectional carbon fiber material is rolled at an essentially 0 degree angle to the longitudinal axis of the grooved mandrel.

15. The method of claim 13, further comprising wrapping a second unidirectional carbon fiber material around the first unidirectional carbon fiber material.

16. The method of claim 15, wherein the second unidirectional carbon fiber material is wrapped at an essentially 90 degree angle to the longitudinal axis of the grooved mandrel.

17. The method of claim 11, wherein the ribs are formed by the grooved mandrel to span substantially the entire length of the shaft.

18. The method of claim 11, wherein the ribs are formed by the grooved mandrel to span a predetermined length along the shaft.

19. The method of claim 11, wherein the grooved mandrel comprises a first mandrel body having the grooves and a second mandrel body without the grooves, said removing of the grooved mandrel comprising removing the first and second mandrel bodies from the shaft in opposite directions relative to one another.

20. The method of claim 19, wherein said removing of the grooved mandrel further comprises detaching the first and second mandrel bodies from one another.
